(19) United States
(12) Patent Application Publication
(10) Pub. No.: US 2023/0193679 A1
(43) Pub. Date: Jun. 22, 2023

(54) Hinge

(71) Applicant: Brolock Pty Ltd, Hornsby (AU)

(72) Inventor: Michael Josef Murauer, Hornsby (AU)

(21) Appl. No.: 17/923,406

(22) PCT Filed: May 10, 2021
(86) PCT No.: PCT/AU2021/050427

§ 371 Date: Nov. 4, 2022

(30) Foreign Application Priority Data
May 11, 2020 (AU) 2020901504

(51) Int. Cl. E05F 3/20; E05F 3/10; E05D 5/02

(52) U.S. Cl. CPC E05F 3/20; E05D 5/0246; E05F 3/104; E05Y 2201/638; E05Y 2900/40; E05Y 2900/114

(57) ABSTRACT

Hinges are disclosed including: a first hinge portion; a second hinge portion; a biasing means; and at least one hydraulic damper; the first and second hinge portions are connected together and are arranged to pivot with respect to one another about a hinge axis between an open condition and a closed condition; the biasing means is arranged to bias the hinge towards the closed condition; the at least one hydraulic damper is compressed from an extended condition to a retracted condition as the hinge moves from the open condition to the closed condition; at least one of the hinge portions is arranged to attach to a gate; and wherein the at least one damper is located outside of the gate and inside one of the hinge portions.

### CROSS REFERENCE TO RELATED APPLICATIONS

The present application is a 371 U.S. National Stage of International Application No. PCT/AU2021/050427, filed May 10, 2022, which claims the benefit of the earlier filing date of Australian Patent Application No. 2020901504 filed on May 11, 2020, which are each incorporated herein by reference in their entirety.

### TECHNICAL FIELD

The present invention relates to hinges and particularly relates to hinges for use with pool fences and in particular with glass panels such as doors in glass pool fences and shower screen doors.

### BACKGROUND

Pool fences and shower screens will often include a gate or a glass door or the like which is affixed with hinges to another structural member such as an upright post or adjacent panel to allow the door to be opened and closed. Such hinges will often include some type of biasing means such as a spring which biases the door to its closed position. This means that if the door is pushed open and then released, it will swing back to its closed position.

In order to try to prevent the biasing means from slamming the door shut, which could cause damage to the door, or injury to nearby persons, it has been tried to provide some type of damping mechanism in the hinge in the form of one or more hydraulic dampers. These dampers typically involve a chamber and a moveable plunger mounted inside the chamber. An amount of viscous fluid is also provided in the chamber and as the plunger moves the viscous fluid is forced to pass through a small aperture or other restriction. The intended effect of the damper is to slow the closing of the door.

The hinges are typically attached to glass door or fence panels by way of insert components which locate in an aperture provided in the glass panel. The dampers are located inside the insert components and move in a direction which is orthogonal to the hinge axis and coplanar with the panel i.e. lying between the planes of the two planar surfaces of the panel.

The dampers are selected so that they provide an overall damping effect such that the door closes slowly, but does not take a very long time to close. However, it has been found that the damping action of these hydraulic dampers is somewhat variable and it can be difficult to achieve the desired damping characteristics.

There remains a need for improved hinges.

### SUMMARY

In a first aspect the present invention provides a hinge including: a first hinge portion; a second hinge portion; a biasing means; and at least one hydraulic damper; the first and second hinge portions are connected together and are arranged to pivot with respect to one another about a hinge axis between an open condition and a closed condition; the biasing means is arranged to bias the hinge towards the closed condition; the at least one hydraulic damper is compressed from an extended condition to a retracted condition as the hinge moves from the open condition to the closed condition; at least one of the hinge portions is arranged to attach to a gate; and wherein the at least one damper is located outside of the gate and inside one of the hinge portions.

The gate may be a glass panel and the hydraulic damper is located outside of the planes which describe the faces of the glass panel.

The damper may move in a direction which is substantially parallel to the hinge axis.

The hydraulic damper may be actuated by way of a cam.

The hydraulic damper may include a sloped surface provided at one end and the cam moves across the sloped surface to compress the damper during a hinge closing operation.

The hydraulic damper may include a second sloped surface provided at the other end of the damper and a second cam which moves across the second sloped surface to thereby compress the damper from both ends.

The movement of the cam may cause rotation of its associated sloped surface.

The sloped surface or surfaces may be helical.

The cam may include a roller.

### BRIEF DESCRIPTION OF THE DRAWINGS

Embodiments of the present invention will now be described, by way of example only, with reference to the accompanying drawings, in which:

FIG. 1 is a perspective view of a hinge;

FIG. 2 is a rear perspective view of the hinge of FIG. 1

FIG. 3 is a cross sectional view of the hinge of FIG. 1 shown attached to glass panels;

FIG. 4 is an exploded view of the hinge of FIG. 1;

FIG. 5 is a partially disassembled rear view of the hinge of FIG. 1;

FIG. 6 is a rear perspective view of another embodiment of a hinge shown in the approximately 40 degrees open position;

FIG. 7 is a rear view of the hinge of FIG. 6;

FIG. 8 is a top view of the hinge of FIG. 6; and

FIG. 9 is a rear view of a modified version of the hinge of FIG. 6.

### DETAILED DESCRIPTION

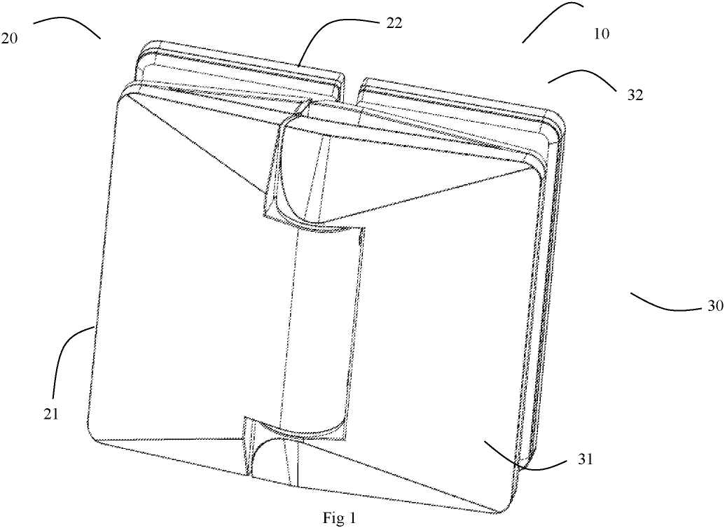

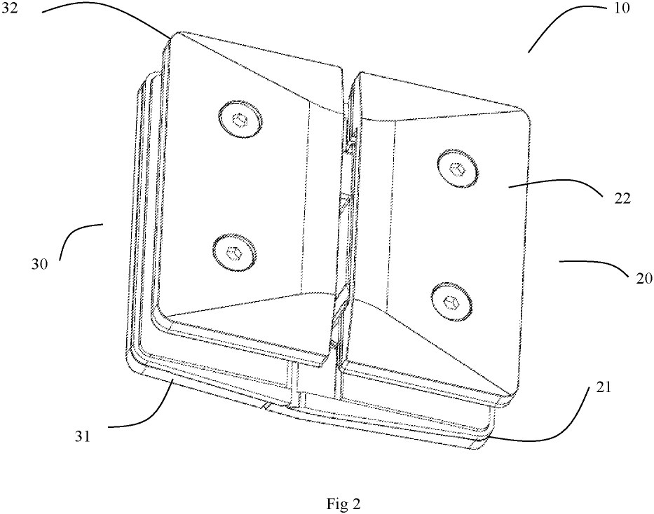

Referring to FIGS. 1 to 5, a hinge 10 for use with glass panels such as glass pool fence or door panels is shown including a first hinge portion 20 which is connected and arranged to pivot with respect to second hinge portion 30 between a closed condition as shown in FIG. 1 and an open condition about a hinge axis.

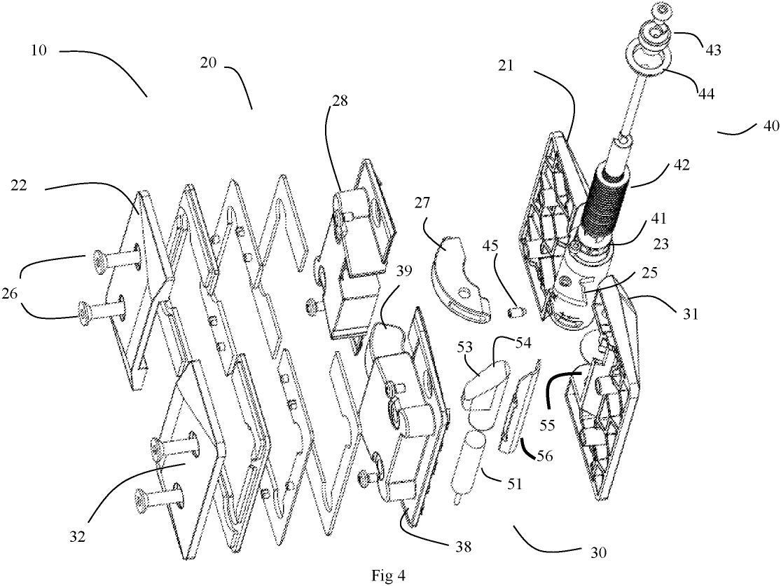

First hinge portion 20 includes first hinge member 21 and first clamping member 22 and second hinge portion 30 includes second hinge member 31 and second clamping member 22. The hinge 10 is arranged to be attached to glass panels using a technique in which the glass panels are pre-machined to provide edge recesses in the glass panel of known profile and locations. Insert portions 28, 38 (see FIG. 4) locate in the edge recesses apertures provided in the glass panels. The hinge portions 20, 30 mount to the glass panels 100, 101 by sandwiching the glass panels and insert portions 28, 38 between the respective pairs of hinge members 21, 31 and clamping members 22, 32 covers using an arrangement of inserts and gaskets, secured with hex-head screw fasteners 26. The hinge members 21, 31, and the clamping members 22, 32 are formed by moulding them from stainless steel.

As best seen in FIG. 4, hinge 10 includes a biasing means in the form of a bearing and spring tensioner assembly 40 which is arranged to bias the hinge 10 towards the closed condition. The spring tensioner assembly 40 also acts as a pivot for the hinge axis about which the hinge members 21, 31 can rotate with respect to one another.

The bearing and tensioner assembly 40 includes a tensioning member 41 which is indexed by a series of circumferentially spaced holes which allow it to be rotated with a tool as will be later described. Assembly 40 further includes a spring 42 and a coupling 43.

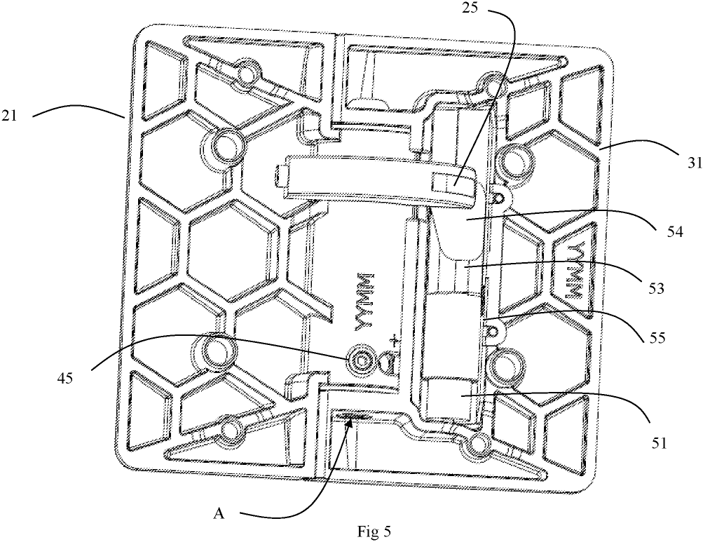

The tensioner assembly 40 is housed in a hollow barrel portion 23 of first hinge member 21. A nose portion of tensioner member 41 is received in a corresponding hole in second hinge member 32 (indicated by arrow A in FIG. 5) to form a lower bearing region. The upper end of spring 42 engages with coupling 43 which in turn engages with formations (not shown) provided on second hinge member 31 which prevent the coupling from rotating with respect to the second hinge member 31. A bush 44 in the upper end of barrel 23 forms an upper bearing region with the coupling 43 rotating inside the bush 44. Spring 42 provides a biasing force to bias the hinge towards its closed condition as seen in FIGS. 1 to 5.

The amount of pre-tension in spring 42 can be adjusted by way of locking pin 45. A small tool (not shown) is inserted into one of the circumferential holes on the tensioner, the locking pin 45 is temporarily withdrawn, and the tensioner 41 is then rotated incrementally and the locking pin re-engaged with a different hole until the desired pre-tension is achieved.

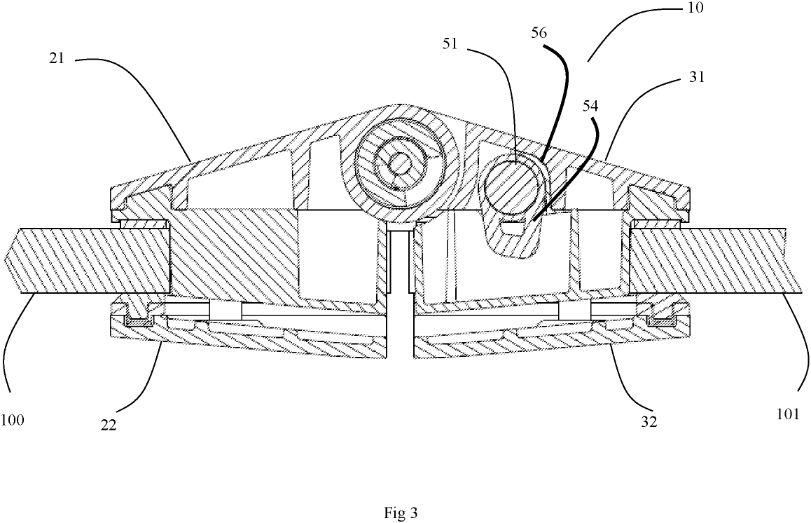

Hinge 10 further includes a damping mechanism which includes a spring loaded hydraulic damper 51 which is housed inside sleeve 53. A damper with a rated capacity of between 300N to 500N is typically suitable for a regular sized glass pool fence door. The damping mechanism is located in a cavity or well provided in the second hinge member 31 (as best seen in FIG. 3). The damper 51 is thereby arranged to move in a direction which is parallel to the hinge axis. The barrel portion 22 of first hinge portion 21 includes a rotary cam 27 which is fitted to arm 25. The cam 27 controls movements of the damper during door opening and door closing operations as will now be described. Cam 27 describes a wide arc and is also protected by a guard portion 39 which reduces the possibility of a person’s fingers becoming inadvertently pinched in the hinge when the hinge is opened and closed during use.

When the door to which the hinge is attached is in its normally closed condition then the hinge is said to be “closed” and this is the condition in which the hinge 10 is depicted in the figures. When the hinge is in the closed condition, the spring loaded hydraulic damper 51 is in its retracted (i.e. compressed) position and is maintained in that position by cam 27 which bears against an upper region of the sloped surface 54 of sleeve 53.

When the door to which the hinge is attached is opened, then the hinge moves to its open condition against the force of biasing spring 42. The rotary cam 27 rotates away from the housing 53 and the damper 51 is free to expand under its own internal spring pressure to adopt its extended position. When in the extended position, the damper 51 is ready to provide a damping action when the door (and hinge) close. Whilst the door (and hinge) are open then they must be held in this position against the spring force of the biasing spring 42.

If the door to which the hinge is attached is released, then the biasing spring 42 causes movement of the hinge (and the door) towards its closed condition. As hinge 10 moves from the open condition to its closed condition, the cam 27 approaches the sloped surface 54 of sleeve 53. Contact between the cam 27 and the lower region of surface 54 commences when the hinge is at about a 35 degree angle away from its closed condition. This causes a rapid deceleration in the angular velocity of the closing door. The biasing spring 42 then continues to bias the door to its closed condition and effects continued movement of the hinge towards the closed condition against the drag induced by the hydraulic damper 51 which becomes gradually depressed. The cam 27 slides across surface 54 as the hinge closes, depressing the damper, until the hinge and door gently comes to rest in its closed condition with the damper again retracted.

The cam 27 makes a region of contact with the face of the sleeve which is a line of contact. The line of contact moves up the face of the sleeve during the compression phase of the hinge closing action. This action also gives rise to a small amount of anti-clockwise direction (as viewed in FIG. 3) by the sleeve 54 during the hinge closing operation. This is because the direction of the line of contact between the cam and the face of the sleeve will always by radially oriented to the centre of rotation of the cam, whereas the line of contact moves radially about the centre of rotation of the cam during the closing operation. The sleeve 54 moves against a slider 56. The rotation of the sleeve assists in preventing a build up of debris between the sleeve and the slider. A debris build up between these parts could impede the smooth and consistent operation of the damping mechanism.

The damper 51 is not mounted inside the insert component. As best seen in FIG. 3, it is mounted outside of the glass panel, to one side of the glass panel in a well in one of the hinge members. This means that the length of the damper is not constrained to fit inside the inert, which in turn must fit inside the edge aperture formed in the glass panel. This allows use of a damper of longer length, which can provide a more significant damping effect when compared with damper of shorter length.

In some embodiments the damping effect can be customized by varying the damper assembly face 54 surface geometry which varies the speed of the dampers depression and alters the resistance force. (can provide varied damper resistance dependent on the gate angle). For instance, the face 54 can be formed from a sandwich type arrangement of materials of varying hardness and Coefficient of friction

In some embodiments the damper face may vary its geometry due to temperature and deformation under load results in a more desirable damping effect at elevated temperature. For instance, the damper face may be helical in shape.

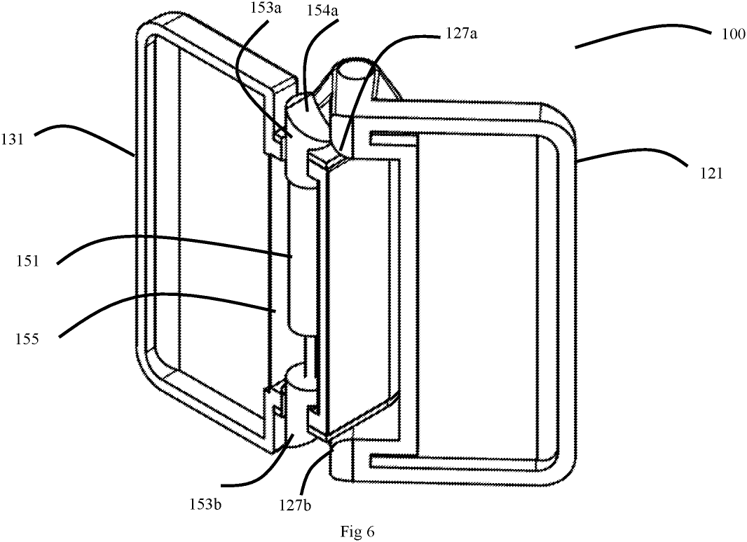

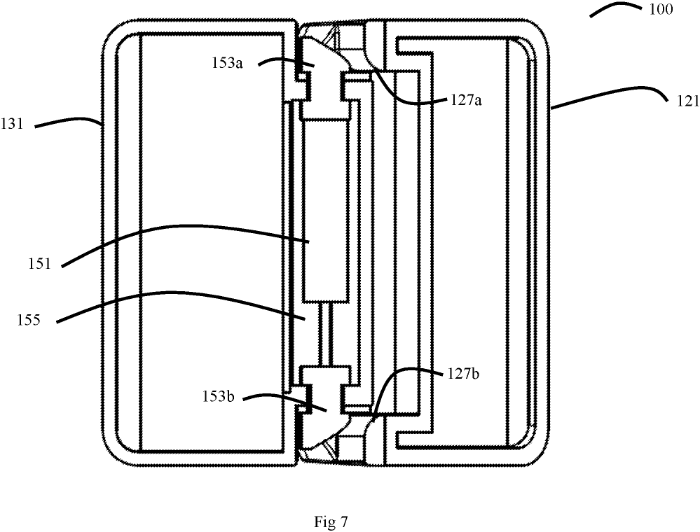

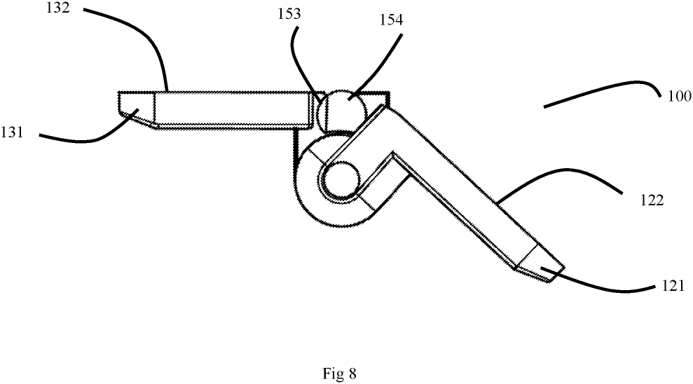

Although the embodiment described above described the hinge in use with a glass door in a glass pool fence, in other embodiments the hinge may be used with a pool fence and gate which are formed from square or round cross section tubular metal components. Such an embodiment will now be described with reference to FIGS. 6 to 8.

Referring to FIGS. 6 to 8, an alternative embodiment of a hinge 100 is shown and like components to the first described embodiment will be referred to with corresponding numbers. Hinge 100 is designed to be surface mounted and used with fence or gate structures formed from extruded metal square sections or glass panels. One side of the hinge is intended to be mounted to a gate panel and the other side of the hinge is intended to be mounted to a fixed structure, such as a post or wall, or adjacent fence panel to form a gate opening.

Hinge portions 121 and 131 are pivotally connected together by way of a biased sprung arrangement largely similar to the first described embodiment. This embodiment differs principally in that the hinge portions 121 and 131 have respective rear planar engagement surfaces 122, 132 which in use are affixed to surfaces of the gate and fence members. No recesses are required to be formed in the fence members as was the case for the first described embodiment. The hinge portions may be moulded from a polymer or metal material.

A damper 151 is located in a cavity 155 provided in hinge portion 131. Damper 151 has a first sleeve 153a provided at the upper and of the damper. Sleeve 153a has a sloped helical surface 154a. The opposing hinge portion 121 includes a first cam region 127a which cooperates with the helical surface 154a. Damper 151 also has a second sleeve 153b provided at the lower end of the damper. Sleeve 153b has a sloped helical surface 154b. The opposing hinge portion 121 includes a second cam region 127b which cooperates with the helical surface 154b.

In the figures, the hinge 100 is shown at a 40 degree open position. When released from this position the spring biasing the hinge (not shown) causes relative rotation of the hinge portions 121, 131 towards a closed condition. When the hinge reaches about a 35 degree open position, first cam region 127a comes into contact with first helical surface 154a and second cam region 127b comes into contact with second helical surface 154b.

Continued movement of the hinge portions beyond a 35 degree open position occurs along with compression of the damper at both ends by way of the two cam portions. The damper thereby controls the rate of closing of the hinge to effect a “soft close” motion.

The cam regions 127a and 127b are part cylindrical in shape. This results in a “line” shaped contact region with the corresponding helical surface. The line contact gives a more consistent friction over time and therefore more consistent closing speed. It has also been found that due to the wear properties of this design no lubricant is required.

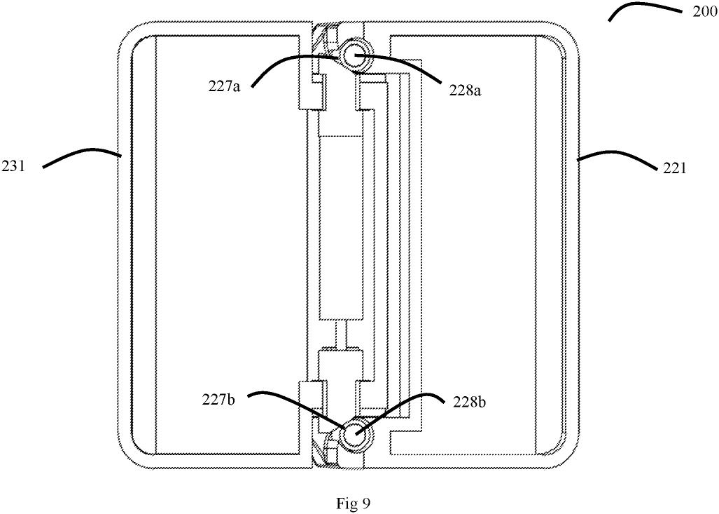

Referring to FIG. 9, a hinge 200 is shown which is a modified version of the hinge of FIG. 6. Hinge 200 differs from hinge 100 in that the cams are provided in the form of rollers 227a, 227b which are rotatably mounted on fixed spindles 228a, 228b which are formed as extensions of the .hinge portion 121. The use of rollers can better accommodate high forces and reduce wear of the hinge parts. In all other respects, the hinge 200 is of the same construction as hinge 100.

The hinge in FIG. 9 utilises cylindrically shaped rollers, but in other embodiments the rollers may be conical in shape.

Although the embodiments described above included a single hydraulic damper, it is possible to use additional dampers to increase the damping force / distance / angle further.

Although the embodiment described above described the hinge in use with a glass pool fence, in other embodiments the hinge can be used with other types of glass panels, such as a glass shower screen door. For example, hinge 100 is designed to be surface mounted and used with fence or gate structures formed from extruded metal square sections or glass panels.

It can be seen that embodiments of the invention have at least one of the following advantages:

The hydraulic damper is mounted in a cavity in one of the hinge members and lies outside of the plane of the panel. This further allows for longer damper travel when compared with hinges in which the dampers are mounted inside one of the hinge insert components and further improves the predictability of the speed and smoothness of the closing action.

The hydraulic damper is mounted so that it moves in a direction which is parallel to the hinge axis. This allows for longer damper travel in a smaller assembly which in turn spreads the resistance force over a longer distance for a more predictable and smoother closing action.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1-9. (canceled)

10. A hinge including:
a first hinge portion;
a second hinge portion;
a biasing member; and
at least one hydraulic damper, wherein:
the first hinge portion and the second hinge portion are connected together and are arranged to pivot with respect to one another about a hinge axis between an open condition and a closed condition;
the biasing member is arranged to bias the hinge towards the closed condition;
in use the at least one hydraulic damper is compressed from an extended condition to a retracted condition as the hinge moves from the open condition to the closed condition;
the first hinge portion includes a first hinge member, and a first clamping member;
the hinge is arranged to attach to a glass panel which is provided with an edge recess, the first hinge portion is arranged to attach to the glass panel by sandwiching the glass panel between the first hinge member and the first clamping member; and
while attached to the glass panel in use the at least one hydraulic damper is located outside of planes which describe faces of the glass panel and inside the first hinge member.

11. The hinge according to claim 10 wherein the damper moves in a direction which is substantially parallel to the hinge axis.

12. The hinge according to claim 10 wherein the at least one hydraulic damper is actuated by way of a cam.

13. The hinge according to claim 12 wherein the at least one hydraulic damper comprises a sloped surface provided at one end and the cam moves across the sloped surface to compress the at least one hydraulic damper during a hinge closing operation.

14. The hinge according to claim 13 wherein the at least one hydraulic damper comprises a second sloped surface provided at an opposite end of the at least one hydraulic damper and a second cam which moves across the second sloped surface to thereby compress the at least one hydraulic damper from both ends.

15. The hinge according to claim 13 wherein movement of the cam causes rotation of the sloped surface.

16. The hinge according to claim 13 wherein the sloped surface is helical.

17. The hinge according to claim 12 wherein the cam comprises a roller.

18. A hinge including:
a first hinge portion;
a second hinge portion;
a biasing member; and
at least one hydraulic damper, wherein:
the first hinge portion and the second hinge portion are connected together and are arranged to pivot with respect to one another about a hinge axis between an open condition and a closed condition;
the biasing member is arranged to bias the hinge towards the closed condition;
the at least one hydraulic damper is compressed from an extended condition to a retracted condition as the hinge moves from the open condition to the closed condition;
at least one of the first hinge portion or the second hinge portion is arranged to attach to a gate;
the at least one hydraulic damper is located outside of the gate and inside one of the first hinge portion or the second hinge portion;
the at least one hydraulic damper moves in a direction which is substantially parallel to the hinge axis;
the at least one hydraulic damper is actuated by way of a cam;
the at least one hydraulic damper includes a sloped surface provided at one end and the cam moves across the sloped surface to compress the at least one hydraulic damper during a hinge closing operation; and
wherein the at least one hydraulic damper includes a second sloped surface provided at an opposite end of the at least one hydraulic damper and a second cam which moves across the second sloped surface to thereby compress the at least one hydraulic damper from both ends.

19. The hinge according to claim 18 wherein the movement of the cam causes rotation of the sloped surface.

20. The hinge according to claim 18 wherein the sloped surface is helical.

21. The hinge according to claim 18 wherein the cam includes a roller.
